(19) United States
(12) Patent Application Publication
(10) Pub. No.: US 2026/0161996 A1
(43) Pub. Date: Jun. 11, 2026

(54) MULTIPLEXED READOUT OF QUBITS FOR AN ERROR CORRECTION CODE

(71) Applicant: COMMISSARIAT À L'ENERGIE ATOMIQUE ET AUX ENERGIES ALTERNATIVES, PARIS (FR)

(72) Inventors: Baptiste JADOT, GRENOBLE (FR); Quentin SCHMIDT, Grenoble (FR); Oscar GRAVIER, Grenoble (FR); Valentin SAVIN, Grenoble (FR)

(21) Appl. No.: 19/392,643

(22) Filed: Nov. 18, 2025

(30) Foreign Application Priority Data
Dec. 6, 2024 (FR) 2413610

(51) Int. Cl. G06N 10/70; G06N 10/40

(52) U.S. Cl. CPC G06N 10/70; G06N 10/40

(57) ABSTRACT

A quantum device includes a plurality of qubits, electrometers coupled to qubits of the plurality of qubits, a voltage generation module generating a plurality of voltages for exciting the electrometers at frequencies, phases or amplitudes specific to each electrometer, and a transmission line for an aggregated signal originating from the electrometers, with the signal being processed, after being picked up by an amplifier, by a demodulation module in order to provide demodulated signals. The plurality of qubits comprises qubits organized as a surface code for correcting quantum errors comprising data qubits for preserving quantum data and auxiliary qubits coupled to the electrometers, with modulations introduced by the voltage generation module into the voltages of the plurality of voltages being dynamically adapted by a modulation assignment module adapted to the code and as a function of the demodulated signal so as to adjust a readout fidelity of the quantum device.

### CROSS-REFERENCE TO RELATED APPLICATION

This application claims priority to foreign French patent application No. FR 2413610, filed on Dec. 6, 2024, the disclosure of which is incorporated by reference in its entirety.

### FIELD OF THE INVENTION

The invention relates to the readout of quantum bits, or qubits. The readout technique involves multiplexing and the implementation of an error correction code.

The field of the invention is that of quantum computing, in particular based on quantum bits (qubits) constructed using technologies based on semiconductor materials, notably silicon, of course, hence the term semiconductor qubits.

### BACKGROUND

Semiconductor qubits have demonstrated that their operation is compatible with temperatures of around 1 K and have high operational fidelity, as described by Huang, J. Y., Su, R. Y., Lim, W. H., et al., in the document entitled, “High-fidelity spin qubit operation and algorithmic initialization above 1 K.” Nature 627, 772-777 (2024). In addition, being able to control a large number of semiconductor qubits in parallel is known. Therefore, the large-scale integration of these qubits is being sought.

Semiconductor qubits can operate by electrostatic potential trapping in order to isolate individual electrons or holes, with the information then being encoded on the spin of the electron or hole, hence, in this case, reference is made to spin qubits.

A distinction is made between NISQ (Noisy Intermediate Scale Quantum computing) implementations, which use a small number (around 10 to 100) of imperfect qubits, and LSQ computation (Large Scale Quantum computation), which involves error correction codes in order to create more reliable logical qubits, in which any errors are efficiently corrected.

LSQ computation involves controlling several thousand to several million qubits in a cryogenic environment. This cryogenic environment has a limited internal volume and a restricted number of cables passing to and from the outside of the enclosure (known as a wired connection bottleneck). In addition, the acceptable thermal power dissipation at the various stages of the cryostat is significantly limited by their temperature, which means that the power consumption of the circuits responsible for controlling and reading the qubits, and which are therefore closest to them in a low-temperature stage, must be restricted. It is therefore imperative that these circuits are optimized.

Therefore, techniques for multiplexing electromagnetic signals adapted to the signals to be transferred through the cryogenic chamber are being developed. Control or readout circuits are also being developed as close as possible to the qubits, possibly distinguishing between successive enclosures with increasing temperatures around a central enclosure containing the qubits.

For the readout of semiconductor qubits in particular, multiplexing techniques have been proposed. Some involve a form of reflectometry, in which the qubit is connected to a resonator. An incident signal is applied to the qubit in order to probe the variations in frequency or resonant amplitude of LC resonators coupled to the various qubits in order to determine their states. By assigning a different resonant frequency to each qubit, the information from each qubit is combined into a single cable, then the signal is demodulated and processed outside the cryostat. However, the size of the L inductors of the LC resonators (100 μm² to 10 mm² per resonator and therefore per qubit) limits the possibilities for large-scale integration. [Jerger 2012, Park 2021, Abdo 2018, Naaman 2021, Bronn 2022].

Another approach involves using wideband amplifiers, with such amplifiers allowing frequency, phase or amplitude multiplexing. [Morel 2022] describes an implementation of this type of frequency multiplexing, as well as signal processing based on integrators and comparators. This approach is advantageous because the manufacturing techniques for qubits and this type of readout circuit are similar, allowing them to be combined in a limited volume at low temperature. The number of qubits simultaneously read is around 10 to 50, and depends, among other things, on the bandwidth of the amplifier (typically approximately 50 MHz) and the desired readout fidelity (99.99% in 1 μs).

With respect to the amplifier, a distinction is made between R-TIAs, which have resistive feedback, and C-TIAs, which have capacitive feedback. C-TIAs can have a higher bandwidth, typically 40 MHz for power consumption of 200 μW[Razavi 2000, Romanova 2019, Schmidt 2024]. This wide bandwidth thus can be divided into various ranges, each assigned to a respective single-electron transistor (SET), and frequency multiplexing of the qubit readout can be performed.

Phase and/or amplitude multiplexing has been proposed by [Schmidt 2023] using the same type of amplifiers. This technique allows the number of qubits per amplifier to be increased (typically by a factor of 5). Phase multiplexing introduces the concept of a constellation, with a constellation being formed by the symbols associated with the 2^{N} combinations of states of N qubits sharing the same frequency. [Schmidt 2023] describes the selection of phases/amplitudes applied to each qubit in order to guarantee maximum fidelity by separating the 2^{N} symbols. Thus, the readout fidelity can be different for each combination of states. In particular, states 00 . . . 0 (with all the qubits in state 0) and 11 . . . 1 (with all the qubits in state 1) can be easily confused and require special attention.

Quantum error correction (QEC) is a technique based on increasing the number of qubits used to encode a given amount of information. This encoding allows errors to be detected and corrected. Errors in quantum computers are related to noise, decoherence and imperfections in the quantum gates.

The purpose of quantum error correction codes (QECC) is to form a few perfect logical qubits from a large number of imperfect physical qubits. In the case of stabilizer correction codes, the qubits are separated into a group of qubits conveying quantum information (data qubits) and a group of qubits that are used to create the logical qubit and to obtain information concerning the errors that have occurred (auxiliary qubits). The no-cloning theorem prevents direct measurement of the data qubits or duplication of their information. However, the auxiliary qubits can be used to perform parity measurements on groups of data qubits. The parity information for each group can be decoded in order to estimate the errors that have occurred in the system and to correct them without affecting the information held by the logical qubit.

Quantum error correction codes thus operate with several physical qubits whose joint state represents a logical qubit. The code is designed so that any errors can be detected and corrected by measuring certain qubits in the code. Repetition codes, Shor codes, Steane codes, and finally surface codes, are known. The surface code is an error correction code that uses a two-dimensional lattice of qubits to encode logical qubits.

For example, [Tomita 2014] describes a quantum error correction code called surface-17 code.

However, until now, signal processing by readout circuits has not been addressed in conjunction with the use of data obtained by signal processing in the context of a quantum error correction code.

More specifically, in most quantum error correction codes, qubit readout is assumed to be simultaneous and to have identical fidelity for all the qubits, without further evaluation of the power consumption of the associated circuits and therefore the practical feasibility.

In addition, conversely, designers of multiplexed readout circuits generally do not take into account the use that can be made of the signals read by their circuits when they are used. These designers also consider each signal to be independent of the others. They therefore do not take into account the expected correlations in these signals for optimizing their circuits.

In addition to or instead of frequency multiplexing, phase, amplitude or phase and amplitude multiplexing of the various single-electron transistors is also introduced. Following demodulation by the frequency f, a complex number (I, Q) is obtained depending on the combined state of the SETs. The set of possible coordinates forms a constellation.

This technique increases the number of SETs per transimpedance amplifier.

More generally, constellations with N SETs are created by selecting the N phases and amplitudes so as to disperse the points (I, Q) associated with one of the 2^{N} combinations of states.

Since the distances between two points in the constellation are not all identical, some combinations of states have greater or lesser readout fidelity. Until now, the practice involved thus defining an average fidelity, by assigning an identical weight to each combination of states.

The inventors wished to improve this practice and better control readout fidelity.

### SUMMARY OF THE INVENTION

To this end, a quantum device is proposed comprising a plurality of qubits, electrometers coupled to qubits of the plurality of qubits, a voltage generation module generating a plurality of voltages for exciting said electrometers with modulations specific to each electrometer, and a transmission line for an aggregated signal originating from the electrometers, with said signal being processed, after being picked up by an amplifier, by a demodulation module applied to the multiplexed information.

Several different frequencies can be used, with each frequency being common to a plurality of qubits, which allows more qubits to be read, but the invention, in general, can be implemented with a single frequency as well as with several frequencies.

In an original manner, the plurality of qubits comprises qubits organized as a quantum error correction surface code comprising data qubits for preserving quantum data and auxiliary qubits coupled to the electrometers, with modulations introduced by the voltage generation module into the voltages of the plurality of voltages being dynamically adapted by a modulation assignment module adapted to the correction code as a function of said demodulated signal so as to adjust, and often maximize, a readout fidelity of the quantum device.

Thus, in the invention discussed herein, a situation is considered in which the probabilities of occurrence of these states differ from each other by several orders of magnitude, and the optimization of the applied frequencies, phases and amplitudes is modified relative to a case in which the probabilities of occurrence of the states would be similar to each other.

The invention is based on the principle, as part of a multiplexed readout, of dynamically using the determination of the state of a given set of qubits to continuously optimize the fidelity of the measurement of these qubits, with the fidelity being the probability of reading a correct result.

More specifically, the determination of the state of the set of qubits is performed before it is used by the quantum error correction codes, and a feedback loop is introduced between the readout of the qubits and the interpretation of the data, which reduces power consumption and readout time, yet without reducing the average readout fidelity.

The observation underlying the process that is used is that, in the presence of errors to be corrected, not all the combinations of states, or syndromes, which are finite in number, determined by the number of qubits and thus forming a list of possible syndromes, are equiprobable.

Furthermore, based on knowledge of the system at a given instant, each syndrome in the list of syndromes can be associated with a probability of occurrence for the next measurement, having first studied all the possible errors on the qubits.

These two properties allow the average readout fidelity to be maximized by favoring the measurement of syndromes where the system is most likely to be at the time of the next measurement. This is entirely original and noteworthy.

According to advantageous and optional features:

A bias of the electrometers (single-electron transistors) coupled to the auxiliary qubits also can be dynamically adapted to adjust said readout fidelity. Using the symmetry of SETs (Single-Electron Transistors) is also proposed with respect to the |0> and |1> states in order to reset the syndrome to 00 . . . 0 after each measurement.

Dynamic adaptation of the modulations can be performed between two successive readouts of the quantum device. A feedback loop is therefore implemented between the result of the latest syndrome measurement and the selection of frequencies, phases and amplitudes, which are then optimized for the next readout based on knowledge of the last measured syndrome, by the error correction code determining the probabilities of the occurrence of syndromes.

The modulation assignment module can take into account acquired knowledge of the hardware characteristics associated with particular error rates of the qubits of the plurality of qubits. Thus, the known hardware characteristic of each qubit (data qubits and auxiliary qubits) is taken into account. For example, if a qubit has a higher error rate than the others, the desired measurement fidelity is increased for all the syndromes involving a change in the state of this qubit. This memory of the individual hardware characteristics of the qubits can evolve over time. Two auxiliary qubits observing the same data qubit can be coupled to electrometers excited at different frequencies. Thus, the auxiliary qubits can be consolidated, reducing their correlations as much as possible, and the groups of auxiliary qubits thus defined can be separated by associating them with different frequencies or by connecting them to different amplifiers. This limits the number of symbols that can be explained by a single error, called first-order symbols, which are the most probable per constellation.

A characteristic dimension, typically a maximum width, measured in a Cartesian plane, for example, the IQ output plane of a quadrature demodulation module, of a region of the plane, which is generally convex, associated with a quantum error syndrome in the code, can be modified by a demodulated information decoding module, advantageously as a function of a probability of occurrence of said syndrome that is computed, for example, by an error correction code module, and in any case at least of one assignment of the modulations performed by the modulation assignment module based on said probability. Indeed, in one embodiment, the signal is demodulated at low temperature and thresholds are then used (for example, using the region of interest (ROI) technique) to determine the state of the auxiliary qubits. This syndrome is then transmitted to the error correction code decoder for analysis and in order to determine the associated error. The thresholds are adjusted relative to the ratios of probabilities of occurrence of the corresponding states, in order to maximize the average readout fidelity.

The module for decoding the demodulated information, which information is often represented in the complex plane, can be inside a cryostat, possibly with several stages, maintaining the qubits at a cryogenic operating temperature. Interpreting the measurement directly at low temperature is actually advantageous in terms of measurement noise and data transfer rates to the electronics placed at a higher temperature. The modulation assignment module nevertheless can be outside said cryostat, in the same environment as the error correction code decoding module, and can provide, via a setpoint, the demodulated information decoding module with detection thresholds and, advantageously, constellations for the purpose of decoding the demodulated information.

An error correction code decoding module can generate a list of probabilities of syndromes for a subsequent readout in view of an analogue signal sent to it by a demodulation module processing the multiplexed signal, and which can be a quadrature demodulation module. Indeed, while performing a hard demodulation has been proposed above, in another embodiment, a soft demodulation is initially performed, only for frequency, without thresholding in the IQ plane and therefore without identification of a symbol, and then the complex numbers (I, Q) obtained at the various frequencies are transmitted to the error correction code. This technique is advantageous because it provides the error correction code with information concerning the measurement uncertainty. If a complex number (I, Q) is too far from the expected symbols, the measurement optionally can be repeated without repeating the extraction of the syndromes.

The multiplexed signal demodulation module can be inside a cryostat maintaining the qubits at a cryogenic operating temperature, with the error correction code decoding module being outside said cryostat.

The code can be the surface-17 code. However, this is one example among others.

Several different frequencies can be used, with each frequency being common to a plurality of qubits, or specific to a single qubit.

Several electrometers from a group of electrometers can be excited at a common frequency and with phases or amplitudes specific to each electrometer from the group, with the demodulation module performing quadrature demodulation by mixing with the common frequency in order to provide a demodulated signal, with the modulations introduced by the voltage generation module comprising phase or amplitude modulations.

Ultimately, the aim is to adjust the discernibility between combinations of states of the same group of auxiliary qubits according to their probability of occurrence. These probabilities of occurrence are estimated for the error correction code used and the error probabilities of the qubits and guide the selection of frequencies, phases and amplitudes applied to each auxiliary qubit. The average readout fidelity, which is defined as the sum of the readout fidelities of each state Fᵢ weighted by the corresponding probabilities of occurrence pᵢ, is maximized.

$${F}_{a v g} = {\sum }_{0}^{N} {F}_{i} {p}_{i}$$

With N being the number of auxiliary qubits.

### BRIEF DESCRIPTI_{ON} OF THE DRAWINGS

FIG. 1 is a non-limiting illustration of a circuit for reading semiconductor qubits by electrometry.

Following on from FIG. 1, FIG. 2 shows a characteristic of a drain current as a function of the gate voltage of electrometers that can be used in the invention and are shown in FIG. 1.

FIG. 3 shows a simple way of distributing the states of a set of 2 qubits in the IQ plane, with phase modulations of 0 and π/2.

FIG. 4 shows an example of an error correction code, called rotated surface-17 code, covering 9 data qubits.

FIG. 5 shows an embodiment of the invention.

FIG. 6 shows a way of distributing the states of a set of 4 qubits in the IQ plane, used in various specific embodiments of the invention.

FIG. 7 shows a particular implementation of the invention, with the distribution of FIG. 6 and the error correction code of FIG. 4.

FIG. 8 shows another particular implementation of the invention, again with the distribution of FIG. 6 and the error correction code of FIG. 4.

FIG. 9 shows details of an implementation used in a specific embodiment, in relation to FIG. 2.

FIG. 10 shows an alternative embodiment of the invention to that of FIG. 5.

FIG. 11 shows another embodiment of the invention.

### DETAILED DESCRIPTION

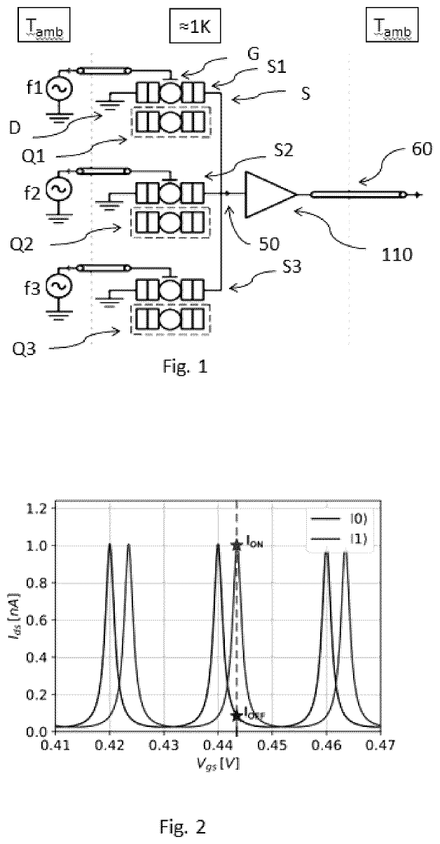

FIG. 1 shows a quantum circuit with semiconductor qubits and qubit readout by electrometry. It operates using a charge readout principle with frequency multiplexing.

The semiconductor qubits are defined from electrons or holes placed in nanostructures similar to a transistor. At a temperature below 4 K, a fixed number of charges can be isolated in quantum boxes, also called quantum dots (QD). For the application discussed herein, two of these quantum dots are placed face to face, but in two different regimes.

The first quantum dot acts as a qubit and contains a small number of electrons and holes, for example, a single electron or a single hole. The spin of the electrons or holes can be used as a two-level system |0> and |1>, for example, but the techniques described herein are applicable to other forms of semiconductor qubits.

The other quantum dot is used as a detector and is operated in a regime called single-electron transistor (SET) regime [Williams 2009, Gong 2019, Morel 2022].

The circuit in FIG. 1 is built around spin qubits on a semiconductor, for example, on silicon, placed in a cryostat at a temperature of around one kelvin (1 K). Each spin qubit is capacitively coupled to a single-electron transistor (SET), placed in contact therewith in the cryostat.

Qubits Q1, Q2 and Q3 are shown, but the invention uses a larger number of qubits, for example, around ten, a hundred or more, consolidated into different groups.

The associated SETs, one per qubit, are referred to as SET S1, S2 and S3, respectively. They each have one or more gates G, as well as a source S and a drain D, which are identified in the figure for SET S1. Depending on the spin of the qubit (i.e., its state, in the case of a spin qubit), the conductance of the SET varies. This effect occurs through capacitive coupling between the respective quantum dots of the qubit and the SET.

The drains D of the SETs are connected to one or more constant (or optionally non-constant) potentials, and, consequently, the SET delivers a current to its source S as a function of the spin of the qubit.

The SETs are voltage-excited by voltage generators, as shown on the left-hand side of the figure. Each SET is excited separately. Different frequencies, f1, f2 and f3, generated by voltage generators are used.

In the embodiment shown, the voltage generators are placed at ambient temperature Tamb and emit signals of a few mV at frequencies ranging from 1 MHz to approximately 100 MHz. They are each connected to the SETs by a transmission line that enters the cryostat. In a variant, it is also possible to place the generators in the cryostat.

The output currents of the SETs, which appear at their source S and are of the order of nanoamperes (nA), are collected and added together to form a total current Iₒᵤₜ on a conductive line 50 in close proximity to the SETs, in the qubit cryostat. This line is common to several qubits, yet nevertheless not being common to all the qubits, in which case another conductive line is present for the other qubits.

The current Iₒᵤₜ is amplified by an amplification chain 110 (comprising one or more amplifiers) and then read by a demodulation circuit.

Thus, frequency multiplexing can occur on the transmission line 50 when the currents are collected. Phase and amplitude multiplexing also can occur.

Quadrature demodulation means are used to separate I and Q components, which are then processed, for each frequency, by analogue-to-digital converters.

The demodulation circuit can be placed at different temperatures, notably at ambient temperature.

There can be only one output cable from the coldest temperature stage for all the qubits, with this output being able to be provided before or after the amplification chain 110, or between two successive segments thereof. The amplification chain 110 actually can be placed at a temperature different from that of the qubits.

The amplification chain 70 comprises a transimpedance amplifier (TIA), which converts the current Iₒᵤₜ into a voltage Vₒᵤₜ that is placed, for example, at the same temperature as the qubits.

The signal on the electromagnetic wave transmission line 60, before demodulation but after conversion by the TIA, is an output voltage.

IQ demodulation extracts the complex I and Q components from the signal and transmits them to an analogue-to-digital converter, which allows the amplitude and the phase of the signal to be placed in the complex plane. These assume the form of constellations of points, called symbols, corresponding to combinations of the states of the auxiliary qubits excited at the frequency.

FIG. 2 shows the characteristic of the drain current Ids (or source current) as a function of the gate voltage Vgs (taken between the gate and the source, or the gate and the drain) for a single-electron transistor.

By applying a low potential difference between the source and the drain of the single-electron transistor, and by varying, along the x-axis in FIG. 2, the voltage applied to the gate of the single-electron transistor, a succession of thin conductance peaks can be observed; the drain-source current in nA is shown on the y-axis in FIG. 2 and it peaks at 1.0 nA, separated by areas of low conductance.

These peaks, called Coulomb peaks, typically have an amplitude of 1 nA and a width of a few mV (2 to 3 mV in FIG. 2). The separation between two peaks is around 10 mV to 100 mV (20 mV in FIG. 2).

The position of the peaks is determined by the electrostatic environment of the quantum dot, which makes the single-electron transistor a very good local electrometer.

In particular, the charge state of the qubit shifts the Coulomb peak of the single-electron transistor, which induces a change in current I_{sd}. FIG. 2 shows that the peaks for the |0>state and those for the |1> state are shifted by approximately 3 mV.

In order to maximize this effect, the gate voltage of the SET VSET is biased to a position where the sensitivity to the charge state of the qubit is maximized. If the SET is sufficiently coupled to the qubit, which is typically the case in semiconductor qubits with high integration power, the Coulomb peak is shifted by a value that is greater than its width at half maximum. This results in a maximum contrast between the two states “0”: I_{OFF} ∓0 nA and “1”: I_{ON} ˜1 nA. This is shown in FIG. 2 for a gate voltage between 0.44 V and 0.45 V, close to 0.443 V.

The readout of the state of a qubit by electrometry involves several conversions. Firstly, in the case of a spin qubit, there is an initial conversion from spin to charge by exchanging charges with another quantum dot (QD) (Pauli blockade readout, or Pauli spin blockade readout) or with a reservoir (Elzerman readout). Next, this charge state of the qubit influences the conductance of the single-electron transistor and modifies the measured output current I_{sd}.

The state of the qubit |0>can correspond to the low “0” or high “1” current level as required, and conversely for the state |1>, which then corresponds to the other state. The bias point VSET is therefore used to select the state of the reference qubit that is to be associated with the lowest current I_{sd}=0 nA.

A transimpedance amplifier (TIA) converts a current into a voltage, with a typical gain of around 106 to 109 V/A. It allows the weak signals produced by the SETs (0.1 to 10 nA) to be amplified to voltages and noise levels compatible with measurement by electronics at ambient temperature. In order to increase their bandwidth and to minimize their noise, it is worthwhile placing these amplifiers at low temperature, or even as close as possible to the qubits and single-electron transistors (SET).

The principle of frequency multiplexing in a transimpedance amplifier (TIA) is based on the transmission of currents with different frequencies over the signal extraction transmission line out of the cryostat, with these frequencies ranging between the lower and upper limits of the bandwidth of the transimpedance amplifier.

With respect to the amplifier, in one embodiment a C-TIA is used and the bandwidth is divided into different ranges, each assigned to a respective single-electron transistor (SET), and frequency multiplexing of the readout is performed, for example, a readout of 1 MHz per SET, or approximately 40 SETs per C-TIA.

A fidelity of more than 99.99% is typically targeted for a read time of 1 μs.

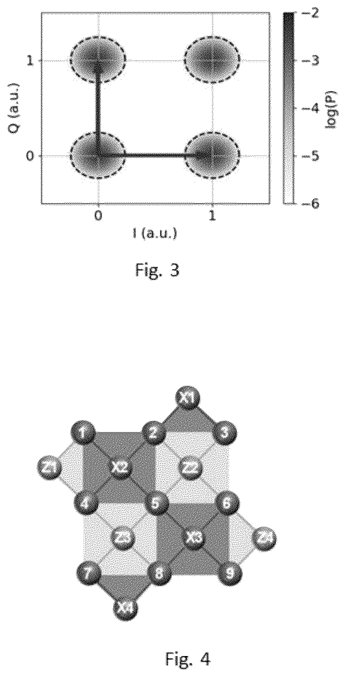

FIG. 3 In addition to or instead of the frequency multiplexing, phase, amplitude or phase and amplitude multiplexing of the various single-electron transistors is also introduced in some variants. For example, signals of the same frequency f but with different phases PA and OB are applied to two SETs A and B. After demodulation by the frequency f, a complex number (I, Q) with four possible values is obtained, depending on the combined state of SETs A and B. All four coordinates together form a constellation.

FIG. 3 shows the case of two-phase multiplexing: 0 and π/2. The real part I is on the x-axis and the imaginary part Q is on the y-axis. The symbols are in the upper right quadrant of the coordinate system (or at its boundary). Given the spread of the measurements linked to the noise of the measurement during the integration of the signal, they assume the form of two-dimensional Gaussian tasks. An ROI (region of interest) boundary is shown as dashed lines, based on the measured intensity shown on a logarithmic scale by the shade that is used.

This two-phase 0 and π/2 multiplexing technique doubles the number of SETs per transimpedance amplifier, without any loss of fidelity or any increase in the consumption of the TIA amplifier.

In one variant, quadrature amplitude modulation (QAM) is used, where the amplitude of the modulation varies in powers of 2 and where the phase alternates between 0, π/2, T and 3π/2.

More generally, constellations with N SETs are created by selecting the N phases and amplitudes so as to maximize the distance between each point (I, Q) associated with one of the 2^{N} combinations of states.

Since the distances between two points in the constellation are not all identical, some combinations of states have greater or lesser readout fidelity.

FIG. 4 shows the arrangement of the qubits used in the surface error correction code 17. This is a surface error correction code. Surface codes are error correction codes that use the characteristics of an array of qubits to protect logical qubits from errors. A two-dimensional lattice of qubits is set up to encode logical qubits. The qubits only interact with their closest neighbors.

In this case, the array is made up of 9 data qubits numbered from 1 to 9 and 8 auxiliary qubits divided into two subgroups, one called subgroup “X” and the other called subgroup “Z”, and identified, in the case of the auxiliary qubits of the first subgroup, as X1 to X4, and in the case of the auxiliary qubits of the second subgroup, as Z1 to Z4. Each data qubit is connected to one or two “X” auxiliary qubits and to the same number of “Z” auxiliary qubits. For example, data qubit 1 is connected to auxiliary qubits Z1 and X2, and data qubit 5 is connected to auxiliary qubits X2, Z2, X3, Z3. Each auxiliary qubit is connected to two or four data qubits. The data qubits are not connected to each other, and the auxiliary qubits are not connected to each other. The whole forms a two-dimensional lattice, hence the term “surface”. The number of qubits 9+8=17 justifies the name “surface-17”.

For example, when an “X” error occurs on qubit 5, with no other errors occurring simultaneously, auxiliary qubits Z2 and Z3 are modified and the other auxiliary qubits, Z1, X1, Z4, X2, X3 and X4, remain unchanged. This result is then interpreted as an “X” error on data qubit 5. This error is stored in a memory and the residual error is tracked until it needs to be corrected by applying the appropriate quantum gates.

“X” type errors are bit flips, while “Z” type errors are phase flips. The correction procedures are known.

The error correction code algorithm periodically measures the syndrome, namely, the set of 8 states of the auxiliary qubits X1-X4 and Z1-Z4.

Then, after the measurement, a decoder determines the most likely error, if one has occurred, explaining this measured syndrome. This error can be the superposition of “X” and/or “Z” errors appearing simultaneously on several data qubits. However, given the low error rate per qubit, the greatest probability is that there are no errors on any of the data qubits.

If it is likely that there has been an error on one or more qubits, the decoder then determines the actions to be implemented in order to correct the identified error.

The correction code is capable of correcting a number of simultaneous errors (in the sense of coexisting during the measurement) below a maximum number of errors specific thereto. However, surface-17 code corrects only one error at a time. More sophisticated codes nevertheless can correct several errors at once.

By reasoning in the event that there is no Z error and where the syndrome on the X auxiliary qubits is 0000, assuming an initial syndrome on the Z auxiliary qubits of “0000”, and a p=1% error rate for “X” on each data qubit, it is possible to compute the probability of measuring each syndrome during the next readout according to Table 1.

TABLE 1

| | Most probable | |
|---|---|---|
| Syndrome | interpretation on the | |
| (Z4Z3Z2Z1) | data qubits | Probability |
| “0000” | No error | 90.63% |
| “0001” | 1 | 1% |
| “0010” | 2 or 3 | 2% |
| “0011” | 1 + 2 or 1 + 3 | 0.02% |
| “0100” | 7 or 8 | 2% |
| “0101” | 4 | 1% |
| “0110” | 5 | 1% |
| “0111” | 1 + 5 or 2 + 4 or 3 + 4 | 0.03% |
| “1000” | 9 | 1% |
| “1001” | 1 + 9 | 0.01% |
| “1010” | 6 | 1% |
| “1011” | 1 + 6 | 0.01% |
| “1100” | 7 + 9 or 8 + 9 | 0.02% |
| “1101” | 4 + 9 | 0.01% |
| “1110” | 6 + 7 or 6 + 8 or 5 + 9 | 0.03% |
| “1111” | 4 + 6 | 0.01% |

Thus, when faced with a 0000 syndrome, the code estimates that the highest probability is that there was no Z error on the four data qubits.

When faced with a syndrome of 0001, the code estimates that the highest probability is that there was a Z error on data qubit 1 and no other errors.

When faced with a syndrome of 0101, the code estimates that the highest probability is that there was a Z error on data qubit 4 and no other errors.

When faced with a 0110 syndrome, the code estimates that the highest probability is that there was a Z error on data qubit 5 and no other errors.

When faced with a 1000 syndrome, the code estimates that the highest probability is that there was a Z error on data qubit 9 and no other errors.

When faced with a 1010 syndrome, the code estimates that the highest probability is that there was a Z error on data qubit 6 and no other errors.

When faced with a 0010 syndrome, the code estimates that the highest probability is that there was a Z error on data qubits 2 or 3, without being able to distinguish between data qubits 2 and 3 at this stage, and no other errors.

When faced with a 0100 syndrome, the code estimates that the highest probability is that there was a Z error on data qubits 7 or 8, without being able to distinguish between data qubits 7 and 8 at this stage, and no other errors.

The aforementioned syndromes have a probability of occurrence of at least 1%, and include all the syndromes associated with first-order errors.

Each syndrome has a specific probability, and these probabilities differ by several orders of magnitude depending on whether the syndrome corresponds to 0 errors, 1 error or 2 simultaneous errors on the data qubits. In the example described, the readout fidelity of the “0000” state has been maximized, as the error rate is low and therefore the syndrome is likely to be unchanged. Next, the fidelity associated with first-order errors (“0001”, “0010”, “0100”, “1000”, “0101”, “0110” and “1010”) is maximized.

Some second-order errors can be interpreted, sometimes with a simple ambiguity (two or three possibilities, this is the case for syndromes 0011, 0111, 1100 and 1110) or even for syndromes 1001, 1011, 1101 and 1111 there is no ambiguity: they are respectively associated with the combination of an error on data qubit 1 and an error on data qubit 9, the combination of an error on data qubit 1 and an error on data qubit 6, the combination of an error on data qubit 4 and an error on data qubit 9, and the combination of an error on data qubit 4 and an error on data qubit 6.

For some second-order errors, and for all the third- and fourth-order errors, the correction code misinterprets the syndrome as originating from another lower order, and therefore more probable, error. These situations are not individually shown in Table 1. In this example, all these situations correspond to a probability of occurrence of 0.37%.

Other arrangements of physical qubits, different from the surface-17 code, can be used to construct a logical qubit.

The gates applied during syndrome extraction before measuring the state of the auxiliary qubits can include controlled-NOT (C-NOT) gates applied between the auxiliary qubit and each of the data qubits, of which there are four or two, hence the use of C-NOT gates, for example, four gates. For the Z auxiliary qubits, it is possible for no other gates to be used in addition to those indicated, and, with respect to the X auxiliary qubits, two Hadamard gates can be used in addition.

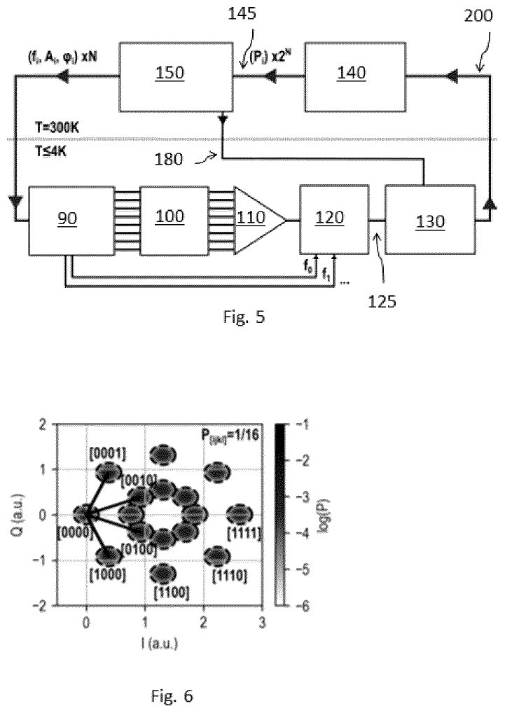

FIG. 5 The invention relates to a phase, frequency and amplitude multiplexed readout of a set of auxiliary qubits.

As shown in FIG. 5, the considered system is a large set of data qubits and auxiliary qubits, where the state of the auxiliary qubits 100 is regularly measured by electrometers, which are themselves connected to an amplification chain 110, which transmits the measured signals to a quadrature demodulator 120 (or more generally a demodulation module processing the multiplexed information provided by the amplification chain 110). For demodulation purposes, said demodulator receives the frequencies that have been generated by sinusoidal voltage generators 90 to read the auxiliary qubits 100: f₀, f₁, etc. The sinusoidal voltage generators 90 synthesize radio frequencies forming voltages in the form of A₀ sin (2πf₀+φ₀) with the triplets A₀, f₀, φₒ provided by an assignment module discussed hereafter, at a rate of one triplet per qubit. In the embodiment shown, the sinusoidal voltage generators 90 and the quadrature demodulator 120 are both in the temperature enclosure at less than 4 K, as are the qubits and the transimpedance amplifier of the amplification chain 110. Thus, the voltages are available in the environment of the quadrature demodulator 120 and there is no need to run a significant number of cables through the wall of the cryostat. These voltages are used as references for demodulation. It is also possible, as disclosed in EP 4016402 A1, but optional, for the cryostat to include two stages, with an internal stage of the cryostat at a lower temperature specifically containing the qubits, the electrometers and the amplification chain, with the voltage generators and the demodulation module being in a stage at a higher temperature but below 4 K. It is also possible for the voltage generators to be placed at ambient temperature, as shown in FIG. 1.

The sinusoidal voltage generators 90, in addition to forming sinusoidal voltages at different frequencies, provide, for each frequency, different phase shifts of the sinusoidal voltage, and also different amplitudes thereof, with each combination being applied to the resonator of a given qubit. Thus, the principles of frequency, phase and amplitude modulation are implemented in order to read a high number of qubits, with a limited number of transimpedance amplifiers, or even a single transimpedance amplifier, if its bandwidth allows.

The frequency, phase and/or amplitude modulation techniques described above are thus applied to a set of auxiliary qubits whose state is to be determined. The selection of optimal modulations is made outside the cryostat, at ambient temperature (approximately 300 K) in an assignment module 150. The assignment module 150 provides as many frequency, amplitude and phase triplets as there are auxiliary qubits to be read, in this case N. The frequency, amplitude and phase triplets are also fed by the assignment module 150 to a decoding module in the complex plane 130 that interprets the demodulated information, which is placed in the cryostat at less than 4 K and which receives, from the quadrature demodulator 120 and for each frequency fᵢ, the intensities in the IQ complex plane determined by the quadrature demodulation, in the form of an analogue demodulated signal 125. These intensities are decoded using the constellations and the detection thresholds associated with the frequency fᵢ and are fed, as part of a setpoint 180, by the assignment module 150 to the decoding module in the complex plane 130.

The decoding module in the complex plane 130 feeds the decoded states forming a syndrome 200 to the error correction code decoding module 140 that is located outside the cryostat at ambient temperature.

Furthermore, the error correction code decoding module 140 generates the list 145 of probabilities of occurrence Pᵢ of the various states of the auxiliary qubits, in this case numbering 2^{N}. This list is transmitted to the assignment module 150 and used thereby to decide upon the modulations to be performed, and more specifically to define the frequency, amplitude and phase triplets.

The measurement is repeated and is used for observing the occurrence of any errors on the data qubits.

The readout architecture thus defined offers a free choice of frequencies, phases and amplitudes (fk, φk, Vk) applied to each auxiliary qubit of index k, unlike the case of reflectometry-based multiplexing, where the frequency is set by a resonator.

Furthermore, this assignment of frequencies, phases and amplitudes is modified whenever this is advantageous during a series of measurements, for example, in order to isolate the signals relating to certain syndromes intended to be measured more precisely.

In order to minimize readout errors, the expected correlations between the states of the various auxiliary qubits for the same error on the data qubits are taken into account and the auxiliary qubits are consolidated according to these correlations.

By spectrally separating two auxiliary qubits that observe the same data qubit in distant frequency bands, the number of points with a high probability of occurrence in the same constellation, at the same demodulation frequency, is thus minimized.

Thus, for a given demodulation frequency, the probability of occurrence of states 1100, 1010, 1001, 0110, 0101 and 0011 transitions from ˜p to ˜p², namely, the probability of two independent errors.

A table of probabilities of occurrence is established for each state. From a given syndrome, the probability of measuring each syndrome (the same syndrome, and also each of the other 2^{N}-1 syndromes) during the next readout is estimated.

On this basis, the phase, the amplitude and the frequency assigned to each auxiliary qubit for the purposes of its readout are adjusted so as to maximize the average readout fidelity of the 2^{N} syndromes, with the readout fidelities of each syndrome being weighted by the probability of occurrence of the syndrome for the purposes of computing the average fidelity.

Therefore, the problem amounts to considering the 2^{N} probabilities Pᵢ obtained by virtue of knowing the error correction code that is used as input parameters, and determining N frequency/phase/amplitude triplets (fk, φk, Vk) that maximize F_{avg}=2 Fᵢ×Pᵢ.

Furthermore, this optimization can take into account characteristics specific to each physical qubit, such as a higher error rate for a data qubit or an auxiliary qubit, linked to the known hardware implementation.

FIG. 6 shows a constellation obtained by modulating 4 SETs with phases (−3π)/8, (−π)/8, π/8 and π/8. The 24=16 states appear as two-dimensional Gaussian peaks, and therefore as essentially circular spots. State 0000 is centered on the point I=0 Q=0. An ROI (region of interest) boundary is shown as a dashed line, based on the expected intensity depicted on a logarithmic scale by the shade that is used, assuming that the 16 states are equiprobable (P=1/16 for 0000, 0001, . . . , 1111). The threshold in the IQ plane is a curvilinear curve in the (I, Q) plane, a straight line or a contour such as a circle or a rectangle around the zone of the plane associated with one of the two states and therefore can be a circle as shown in the figure.

The states are not evenly spaced apart: 8 of them, including state 0000, but also states 0001, 0011, 0111, 1111, 1110, 1100 and 1000, are on a large diameter circle centered on the point on the x-axis close to I=1.4, and 8 others, including states 0010 and 0100, are on a small diameter circle, approximately half the diameter of the large circle, and with the same center as the large circle.

This distribution provides, for example, better readout fidelity for state [1000], which is on the large diameter circle and whose peak does not have any close neighbors, than for state [0100], which is on the small diameter circle and is very close to two other peaks in the constellation.

FIG. 7 Therefore, thresholds are used that are adapted to distinguish between the states associated with various distributions of probabilities between two neighboring peaks, different from the 50%-50% distribution that was implicitly used in FIG. 6. To this end, the dimension in a plane of the region of interest associated with a syndrome is modified by the decoding module in the complex plane 130 as a function of the probability of occurrence of the syndrome provided by the list 145, and the assignment of modulations undertaken by the assignment module 150 based on said probability.

Thus, between two states to be distinguished, the a priori probability can be distributed, for example, in the form of 20% for the first state and 80% for the second state. The threshold in the IQ plane is a circle with a center that remains unchanged from the choice made with reference to FIG. 6, but with a radius that is adapted to maximize the average fidelity F_{avg}=P₀×F₀+P₁×F₁.

FIG. 7 more specifically shows the phase-multiplexed readout of the auxiliary qubits X1, X2, X3 and X4 as part of the surface-17 correction code, for an error rate for Z-type errors of p=1% on data qubits 1 to 9 and an initial syndrome [0000]. As shown on the left-hand side of the figure, auxiliary qubit X3 has a phase of π/8, auxiliary qubit X2 has a phase of

$$- \frac{π}{8} ,$$

auxiliary qubit X4 has a phase of

$$\frac{3 π}{8} ,$$

and auxiliary qubit X1 has a phase of −3π/8.

The optimized thresholds for this case are shown as dashed lines in the complex plane shown on the right-hand side of the figure. The state [0000] is the one with the highest probability and has been assigned a threshold in the form of a circle with a large radius, followed by states [1000], [1100], [0001], and [0011] on the large circle and [0100], [0110] on the small circle, which have thresholds in the form of circles with intermediate radii. The other states, with lower probability, involve at least two independent errors and have thresholds in the form of circles with smaller radii. Thus, states [0100], [0010], [0110] have a reduced probability of being confused with another state, despite their position on the small circle.

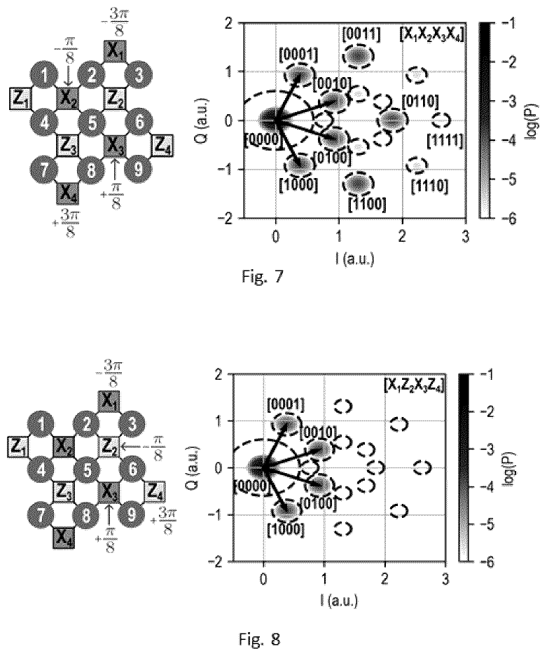

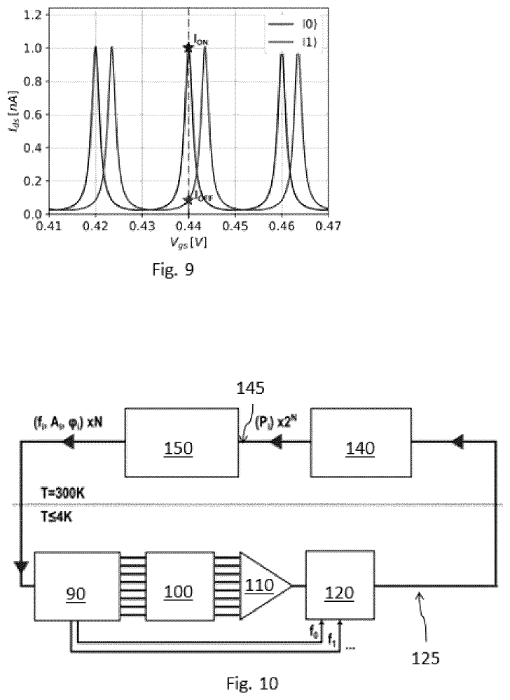

FIG. 8 shows, again as part of the surface-17 correction code, and for an error rate for Z-type errors of p=1% on data qubits 1 to 9 and an initial syndrome [0000], the phase-multiplexed readout of a group of auxiliary qubits, some of which are X category and others are Z category qubits. Specifically, FIG. 9 shows X1, Z2, X3 and Z4. As shown on the left-hand side of the figure, auxiliary qubit X3 has a phase of π/8. Auxiliary qubit Z2 has a phase of

$$- \frac{π}{8} .$$

Auxillary qubit X1 has a phase of

$$\frac{- 3 π}{8} .$$

Auxillary qubit X4 has a phase of 3π/8.

Since the group of auxiliary qubits X1, Z2, X3 and Z4 does not contain any pair of auxiliary qubits observing the same type of error on the same data qubit, the probability of obtaining states [1100] and [0011] (on the large circle) and [0110] (on the small circle) is reduced compared to the situation in FIG. 7, which improves the average measurement fidelity in the complex plane (right-hand side of the figure).

The optimized thresholds for this case are again shown as dashed lines. State is the one with the highest probability and has been assigned a threshold in the form of a large radius circle, followed by states [1000], [0100], [0010] and [0001], which have thresholds in the form of circles with intermediate radii. The other states, with lower probability, involve at least two independent errors and have thresholds in the form of circles with smaller radii, notably [1100], [0011] and [0110], which are shown in FIG. 7 for the sake of comparison.

Preferably, auxiliary qubits with the lowest possible correlations should be consolidated at the same frequency in order to obtain a constellation with as few high-probability states as possible.

FIG. 9 Furthermore, after decoding a syndrome in the complex plane and before the next measurement, it is worthwhile storing this syndrome as a new reference state before a new extraction of a syndrome.

To this end, and as shown in FIG. 9, the bias points of each single-electron transistor, the electrometers, in state “1” in the result of the last decoding in the complex plane, are modified so as to set the relevant state as state “0” by convention. In this way, the next measurement systematically yields “00 . . . 0” when no parity change occurs and therefore no error can be detected by the error correction code. The syndrome is thus reset to “00 . . . 0”.

In FIG. 9, compared to FIG. 2, the bias point of the gate of the transistor acting as an electrometer for the auxiliary qubit that has been identified as being in state 1 is set to 0.44 V, whereas it was previously at approximately 0.443 V. Thus, the bias of the electrometers coupled to the auxiliary qubits is dynamically adjusted so as to adjust said readout fidelity: the distribution of peaks in the complex plane is again that shown in FIG. 7 (right-hand side of the figure) or FIG. 8 (right-hand side of the figure).

Thus, in the specific case of syndromes with a very low probability of occurrence linked to several independent physical errors, the probability ratio with the other states is taken into account in order to determine the optimal region of interest (ROI), as explained above. In some cases, these unlikely states can be ignored in order to maximize the overall fidelity of the measurement. As shown in FIG. 5, one embodiment anticipates that the decoding in the complex plane is performed at a low temperature, i.e., in the cryostat at less than 4 K, at the temperature the qubits are placed under.

In one embodiment, a demodulation is performed at low temperature, followed by the application of thresholds in order to determine the measured syndrome.

This method has the advantage of interpreting the measurement directly at low temperature (<4 K), which is advantageous in terms of the measurement noise and the data transfer rate to the electronics placed at ambient temperature (approximately 300 K).

FIG. 10 However, according to a variant shown in FIG. 10, soft frequency demodulation is performed. The quadrature demodulator 120 is again in the low-temperature cryostat (<4 K) and provides the error correction code decoding module 140, which is still in the external environment (approximately 300 K), not with a syndrome but in the form of an analogue signal, a complex number (I, Q) for each frequency. The decoding module in the complex plane 130 is removed. By removing the thresholding that this module 130 performs in the previous embodiment, the error correction code decoding module 140 is provided with richer information in terms of the fidelity of the measurement, namely, information including a distance between the actual measured value and the closest expected value.

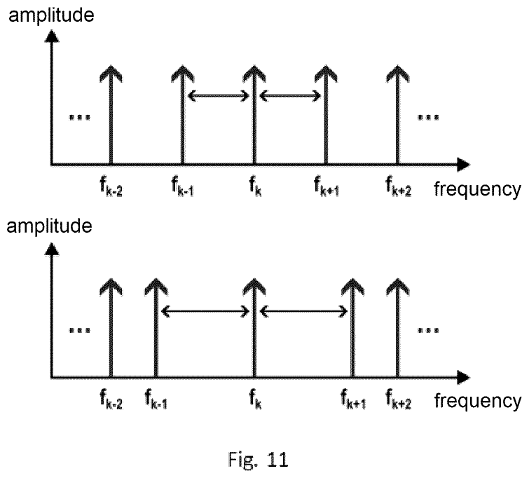

FIG. 11 shows an adaptation of the frequency, with, for example, a single qubit per frequency. The figure has an upper section and a lower section, each with the x-axis showing the frequencies f1, f2, f3 . . . (FIG. 1) at which the excitations are generated by the sinusoidal voltage generators 90.

In the upper section of the figure, the frequencies are evenly spaced apart and the readout fidelity is the same at all the frequencies, the readout fidelity is homogeneous across all the different qubits.

In the lower section of the figure, the separation between a particular frequency fₖ and the neighboring frequencies has been increased. The frequencies fk-1 and fₖ₊₁ are respectively closer to the frequencies fₖ₋₂ and fₖ₊₂, as a result, these remain unchanged or are shifted but to a lesser extent. In any case, the frequencies fₖ₋₂ and fₖ₊₂ are located in a more congested environment than fk, as the available frequency band is limited.

For an identical signal integration time for all the qubits, the readout fidelity is then better for the frequency fk, and therefore for the associated qubit, than for the frequencies fₖ₊₂, fₖ₊₁, fₖ₋₁ and fₖ₋₂ and the associated qubits. Therefore, the readout fidelity is better for the qubit associated with the frequency fₖ than for the qubits associated with the other frequencies.

According to the invention, the assignment module 150 (FIG. 5 or FIG. 10) dynamically adapts the assigned frequencies and their respective spacing subject to the constraint of the bandwidth of the amplification chain 110 (FIG. 5 or FIG. 10), in order to adjust the readout fidelity of the qubits as a function of the priorities defined by the assignment module 150, notably based on the probabilities of occurrence Pᵢ of the various states of the auxiliary qubits.

For each readout step, it is thus possible to specifically separate two or more states, at least one of which is to be better discerned at the expense of other states for which the measurement can be less accurate for reasons similar to those mentioned above. The frequency sent to each single-electron transistor is then dynamically adjusted instead of maintaining regularly spaced apart frequencies.

### REFERENCES

[Park 2021] Park et al., “A fully integrated cryo-CMOS SoC for state manipulation, readout and high-speed gate pulsing of spin qubits”, IEEE Journal of solid state circuits, volume 56, No. 11, 3289-3306.
[Jerger 2012] M. Jerger et al., “Frequency division multiplexing readout and simultaneous manipulation of an array of flux qubits”. Appl. Phys. Lett. 23 Jul. 2012; 101 (4): 042604.
[Gong 2019] M. J. Gong et al., “Design Considerations for Spin Readout Amplifiers in Monolithically Integrated Semiconductor Quantum Processors”, 2019 IEEE Radio Frequency Integrated Circuits Symposium (RFIC), Boston, MA, USA, 2019, pp. 111-114.
[Rasavi 2000] B. Razavi, “A 622 Mb/s 4.5 pA//spl radic/Hz CMOS transimpedance amplifier [for optical receiver front-end]”, 2000 IEEE International Solid-State Circuits Conference. Digest of Technical Papers (Cat. No.00CH37056), San Francisco, CA, USA, 2000, pp. 162-163.
[Ramanova 2019] A. Romanova, et al., “A Review of Modern CMOS Transimpedance Amplifiers for OTDR Applications”. Electronics 2019, 8, 1073.
[Tomita 2014] Tomita, Yu, and Krysta M. Svore. “Low-Distance Surface Codes under Realistic Quantum Noise”. Physical Review A 90, No. 6 (11 Dec. 2014): 062320.
[Morel 2022] copy of EP 4016402 A1.
[Abdo 2018] copy of WO 2018/185542A1.
[Naaman 2021] WO 2021/061776 A1.
[Bronn 2022] US 2022/0140927 A1.
[Williams 2009] EP 2075745A1.
[Schmidt 2023] patent application FR 2306530 dated 22 Jun. 2023.
[Schmidt 2024] patent application FR2403977 dated 17 Apr. 2024.

1. A quantum device comprising a plurality of qubits, electrometers coupled to qubits of the plurality of qubits, a voltage generation module generating a plurality of voltages for exciting said electrometers with modulations specific to each electrometer, and a transmission line for an aggregated signal originating from the electrometers, said signal being processed, after being picked up by an amplifier, by a demodulation module, the quantum device being characterized in that the plurality of qubits comprises qubits organized as a quantum error correction code comprising data qubits for preserving quantum data and auxiliary qubits coupled to the electrometers, with modulations introduced by the voltage generation module being dynamically adapted by a modulation assignment module adapted to the code as a function of said demodulated signal so as to adjust a readout fidelity of the quantum device.

2. The quantum device as claimed in claim 1, wherein a bias of the electrometers coupled to the auxiliary qubits is also dynamically adapted so as to adjust said readout fidelity.

3. The quantum device as claimed in claim 1, wherein dynamic adaptation of the modulations is performed between two successive readouts of the quantum device.

4. The quantum device as claimed in claim 1, wherein the assignment module takes into account acquired knowledge of any hardware characteristics related to particular error rates of the qubits of the plurality of qubits.

5. The quantum device as claimed in claim 1, wherein two auxiliary qubits observing the same data qubit are coupled to electrometers excited with distinct frequencies.

6. The quantum device as claimed in claim 1, wherein a characteristic dimension of a range or region of values of at least one demodulated quantity, with the range or region being associated with a given quantum error syndrome, is modified as a function of a probability of occurrence of said given syndrome and an assignment of the modulations that is carried out based on said probability.

7. The quantum device as claimed in claim 1, wherein a demodulated information decoding module is inside a cryostat maintaining the qubits at a cryogenic operating temperature, with the assignment module being outside said cryostat and providing, via a setpoint, the demodulated information decoding module with detection thresholds for decoding purposes.

8. The quantum device as claimed in claim 1, wherein an error correction code decoding module generates a list of probabilities of syndromes for a subsequent readout in view of an analogue signal sent to it by a demodulation module.

9. The quantum device as claimed in claim 1, wherein the demodulation module is inside a cryostat maintaining the qubits at a cryogenic operating temperature, with the error correction code decoding module being outside said cryostat.

10. The quantum device as claimed in claim 1, wherein the code is the surface-17 code or another surface code.

11. The quantum device as claimed in claim 1, wherein several different frequencies are used, with each frequency being common to a plurality of qubits, or specific to a qubit.

12. The quantum device as claimed in claim 1, wherein several electrometers of a group of electrometers are excited at a common frequency and with phases or amplitudes specific to each electrometer of the group, with the demodulation module performing quadrature demodulation by mixing with the common frequency in order to provide a demodulated signal, with the modulations introduced by the voltage generation module comprising phase or amplitude modulations.
